(19) United States
(12) Patent Application Publication
(10) Pub. No.: US 2005/0016231 A1
(43) Pub. Date: Jan. 27, 2005

(54) Anti theft locking device

(76) Inventor: John Arthur Stanyer, Kyneton (AU)

Correspondence Address: SHLESINGER, ARKWRIGHT & GARVEY LLP;PATENT, TRADEMARK & COPYRIGHT LAW, 3000 SOUTH EADS STREET, ARLIGTON, VA, 22202, US

(21) Appl. No.: 10/694,406

(22) Filed: Oct. 28, 2003

(30) Foreign Application Priority Data
Oct. 28, 2002 (AU) 2002952289

(51) Int. Cl. B60R 25/02

(52) U.S. Cl. 70/203; 70/209

(57) ABSTRACT

This invention relates to a locking device 1 that immobilises a pedal 10 of the vehicle and the steering wheel 11 to render the vehicle inoperative. The invention encompasses a method for installing the locking device 1. The locking device 1 includes a hooked metal rod 2 for attachment to a pedal 10 and a metal chain 7 linked to the rod 2. The chain is secured to the steering wheel 11 by wrapping the chain 7 tightly around the steering wheel 11 and securing the chain 7 to itself. The steering wheel 11 and pedal are thereby immobilised and prevented from moving relative to each other.

### FIELD OF THE INVENTION

This invention relates to a locking device, and more particularly to an improved locking device for vehicles.

### BACKGROUND OF THE INVENTION

Over the years, one of the most persistent problems encountered in owning a vehicle, such as a motor vehicle, has been the vulnerability of the vehicle to theft.

Numerous solutions to this problem have been proposed in the form of various anti-theft devices. Such anti-theft devices include vehicle immobiliser which, when in operation prevent ignition of the to engine of the vehicle, vehicle alarms, which when triggered sound an alarm to alert persons in the vicinity that the vehicle has been broken into and, anti-theft locking devices which prevent turning of the steering wheel of the vehicle.

Many of the known anti-theft devices have proven to be ineffective in stopping thieves from steeling vehicles. Technology today allows thieves to bypass vehicle alarms and immobilisers and, known vehicle steering locks are able to be broken or sawed through and removed by the thief to allow uninterrupted movement of the steering wheel to a low theft of the vehicle.

U.S. Pat. No. 3,990,280 discloses an anti-theft device consisting of a hook that wraps around the brake lever and a chain extending from the hook to a column-type gear shift lever. A padlock links the chain to the gear shift lever.

While this anti-theft device immobilises the brake pedal, the column-type gear shift lever is not immobilised as there typically is enough free play in the chain and hook to permit radial movement of the gear shift lever relative to the steering column. Moreover, unless the anti-theft device is threaded through the vehicle dashboard, the chain will loop underneath the dashboard from the brake pedal to the gear shift lever. As such gear shift levers are shifted radially about the steering column toward the floor of the vehicle a shift the vehicle into gear, the distance between the gear shift lever and pedal s reduced by this movement and would, therefore, provide enough slack in the chain to unhook the hook from the brake pedal and enable operation of the gear shift lever and brake pedal.

Accordingly, it is desirable to provide ar improved locking device which alleviates or overcomes one or more disadvantages of known vehicle anti theft devices.

### SUMMARY OF THE INVENTION

According to one aspect of the present invention there is provided a locking device comprising:
a pedal attachment member having a first end adapted to be attached to a pedal of a vehicle;
a flexible chain or cable means attached to a second end of the pedal attachment member;
a locking means;
wherein in operation of the locking device, the pedal attachment means is attached to a pedal of the vehicle and the flexible chain or cable means is secured to the steering wheel by the locking means to immobilise the steering wheel and pedal and to prevent relative movement therebetween.

Wrapping the chain or cable means tightly about the steering wheel of the vehicle ensures that any free play in the chain is not sufficient to enable operation of the pedal or steering wheel. That is, movement of the pedal to operate the vehicle typically involves movement of the pedal away from the steering wheel. The locking device restricts movement of the pedal beyond that movement permitted by free play in the chain. Moreover, while the steering wheel may be rotated to a degree, the distance between the s eering wheel and pedal does not diminish, so that further free play cannot arise. Accordingly, the locking device will prevent movement of the pedal and steering wheel such that the vehicle is rendered inoperative.

In the preferred embodiment, the chain o cable means is wrapped tightly around the steering wheel of the vehicle and the chain or cable means is secured to itself by the locking means.

The first end of the pedal attachment member is preferably formed in the shape of a hook which is adapted to hook onto one of the pedals, e.g. the clutch or brake pedal of a vehicle. The pedal attachment member preferably comprises a rod of high strength metal, although other high strength materials may be used.

In a preferred embodiment, the pedal attachment member, the chain or cable means and the locking means are constructed of a high tensile material to resist cutting by bolt-cutters, a hacksaw or the like.

The flexible chain or cable means is preferably a metal chain, which can be formed into a loop with the locking means securing two links of the chain together.

Preferably, the locking means is a padlock. Still preferably, the locking device is an “anti-pick” lock.

A second aspect of the invention provides a method for installing the locking device according to the first aspect, the method including the steps of:
attaching the pedal attachment member to the pedal of the vehicle;
wrapping the flexible chain or cable means around the steering wheel; and
securing the chain or cable means to the steering wheel such that the steering wheel and pedal are immobilised and that relative movement therebetween is prevented.

In a third aspect the invention provides a locking device according to the first aspect, wherein the pedal attachment means is attached to the pedal of the vehicle and the flexible chain or cable means is secured to the steering wheel to immobilise the steering wheel and pedal and to prevent relative movement therebetween.

### BRIEF DESCRIPTION OF THE DRAWINGS

A preferred embodiment of the present invention will now be described, by way of example only, with reference to the accompanying drawings in which:

FIG. 1 is a side view of a locking device n accordance with the invention;

FIG. 2 is a front view of the locking device of figure one; and

FIG. 3 is a perspective view of the locking device in use in a vehicle.

### DESCRIPTION OF THE PREFERRED EMBODIMENT

The locking device 1 shown in FIG. comprises a pedal attachment member in the form of a metal rod 2 having a first end 4 adapted to form a hook 3, a chain attachment means 5 in the form of a ring at its second end 6, and a chain 7.

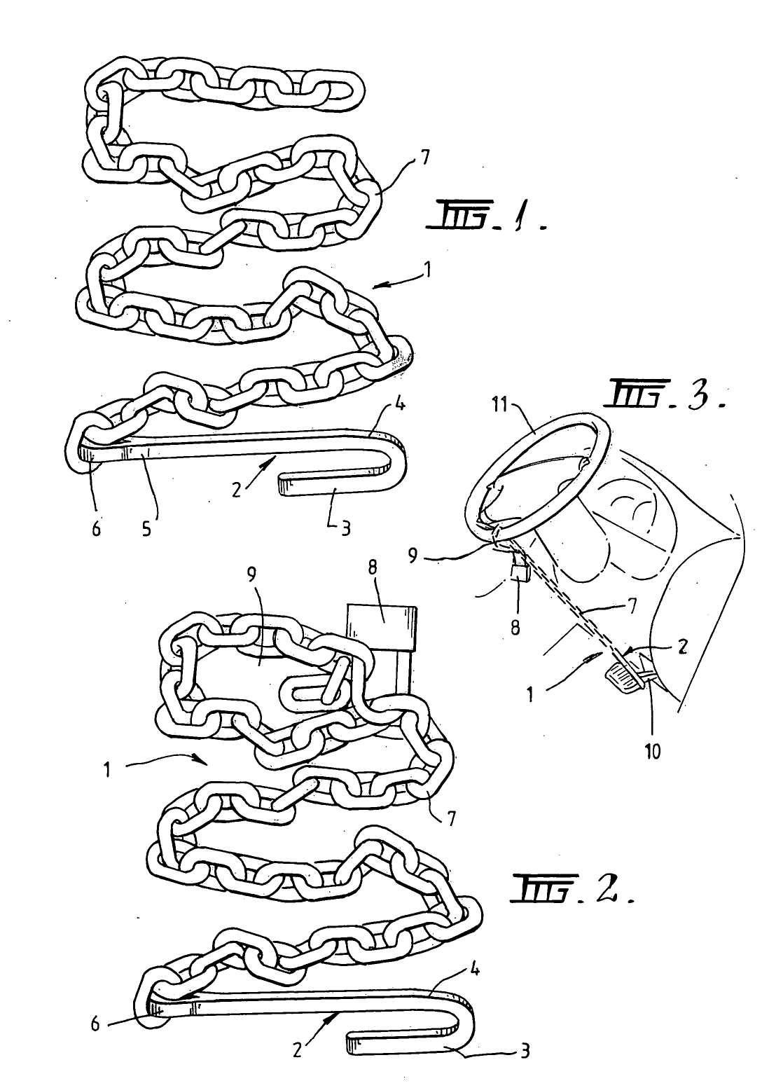

As shown in FIG. 1, a link at one end of the chain 7 is attached to the attachment means 5 of the second end 6 of the rod 2.

As shown in FIG. 2, the chain 7 may be formed into a loop 9 and secured to itself by locking means 8. The locking means 8 preferably comprises a high tensile padlock with the U-shaped locking member extending through links of the chain 7.

FIG. 3 shows the locking device 1 in use in a vehicle. The hook 3 is secured to a pedal 10 of the vehicle and the chain 7 is pulled tightly around steering wheel 11 and secured to itself by the locking means 8. When attached in this manner, the pedal 10 and the steering wheel 11 are inoperable by virtue of the fact that they are immobilised and they cannot move relative to each other.

One of the disadvantages of current steeling wheel locking devices is that thieves can bolt cut or saw through the locking device and remove the locking device. In order to avoid this, the chain 7, the rod 2 and the locking means 8 may be formed of a high tensile material, such as high tensile steel.

The locking device 1 is installed by attaching the hook 3 to a pedal 10 and securing the chain 7 to the steering wheel 11. This is be done either by arranging the padlock 8 to enclose part of the steering wheel 11 and one link in the chain 7 to prevent relative movement between the steering wheel 11 and pedal 10. Alternatively, as shown in FIG. 3, the chain 7 is wrapped tightly around the steering wheel 11 and secured to itself by arranging the padlock to enclose two links of the chain such that relative movement between the steering wheel 11 and pedal 10 is prevented.

It will be understood that the invention disclosed and defined in this specification extends to all alternative combinations of two or more of the individual features mentioned or evident from the text or drawings. All of these different combinations constitute various alternative aspects of the invention.

It will also be understood that the term “comprises” (or its grammatical variants) as used in this specification is equivalent to the term “includes” and should not be taken as excluding the presence o other elements or features.

Reference to any prior art in the specificat on is not, and should not betaken as, an acknowledgement or any form of suggest on that this prior art forms part of the common general knowledge in Australia.

1. A locking device comprising:
a pedal attachment member having a first end adapted to be attached to a pedal of a vehicle;
a flexible chain or cable means attached to a second end of the pedal attachment member;
a locking means;
wherein in operation of the locking device, the pedal attachment means is attached to a pedal of the vehicle and the flexible chain or cable means is secured to the steering wheel by the locking means to immobilise the steering wheel and pedal and to prevent relative movement therebetween.

2. A locking device according to claim 1, wherein the chain or cable means is wrapped tightly around the steering wheel of the vehicle and the chain or cable means is secured to itself by the locking means.

3. A locking device according to claim 2, wherein the first end of the pedal attachment member is formed in the shape of a hook which is adapted to hook onto one of the pedals of a vehicle.

4. A locking device according to claim 3 wherein the pedal attachment member comprises a rod of high strength material.

5. A locking device according to claim 4, wherein the high strength material is metal.

6. A locking device according to claim 4 wherein the pedal attachment member, the chain or cable means and the locking means are constructed of a high tensile material to resist cutting by bolt-cutters, a hacksaw or the like.

7. A locking device according to claim 6, wherein the flexible chain or cable means is a metal chain, which can be formed into a loop with the locking means securing two links of the chain together.

8. A locking device according to claim 7, wherein the locking means is a padlock.

9. A locking device according to claim 8, wherein the locking device is an anti-pick lock.

10. A method for installing the locking device according to claim 1, the method including the steps of:
attaching the pedal attachment member to the pedal of the vehicle;
wrapping the flexible chain or cable means around the steering wheel; and
securing the chain or cable means to the steering wheel such that the steering wheel and pedal are immobilised and that relative movement therebetween is prevented.

11. A locking device according to claim 1, wherein the pedal attachment means is attached to the pedal of the vehicle and the flexible chain or cable means is secured to the steering wheel to immobilise the steering wheel and pedal and to prevent relative movement therebetween.
